(19) United States
(12) Patent Application Publication
(10) Pub. No.: US 2010/0006696 A1
(43) Pub. Date: Jan. 14, 2010

(54) Landing gear noise reduction assembly

(75) Inventors: Leung Choi Chow, Bristol (GB); Philip Campbell, Stockport (GB); Christopher Neil Wood, Congleton (GB)

Correspondence Address: NIXON & VANDERHYE, PC, 901 NORTH GLEBE ROAD, 11TH FLOOR, ARLINGTON, VA, 22203, US

(73) Assignee: AIRBUS OPERATIONS LTD., Bristol (GB)

(21) Appl. No.: 12/458,243

(22) Filed: Jul. 6, 2009

(30) Foreign Application Priority Data
Jul. 9, 2008 (GB) 0812542.9

(51) Int. Cl. B64C 25/16; B64C 23/00

(52) U.S. Cl. 244/1 N

(57) ABSTRACT

An aircraft noise reduction apparatus including an aircraft landing gear assembly (10) and a noise reduction fairing (12) is described. The landing gear assembly comprises (10) a landing gear bay having an aperture (14), a landing gear moveable between a stowed position and a fully deployed position, and at least one landing gear bay door (16) moveable to close and open the aperture. The noise reduction fairing (12) is positioned fore of the landing gear bay door assembly. The noise reduction fairing (12) is moveable between a stowed position and a fully deployed position such that in the fully deployed position, the noise reduction fairing (12) acts to reduce noise that would otherwise be generated by the interaction of the landing gear assembly when deployed and the air flowing past it.

The present invention relates to an aircraft landing gear noise reduction assembly. More particularly, but not exclusively, the invention relates to an aircraft landing gear assembly designed to reduce the noise generated by the interaction of the landing gear and the air flowing past it during flight, landing and/or take-off.

### BACKGROUND OF THE INVENTION

It is desirous to reduce the noise generated by aircraft, especially fixed-wing aircraft and/or aircraft that cannot land vertically, for example, to lessen disruption or inconvenience, resulting from aircraft noise, caused to the public on the ground near airports. A significant amount of noise is generated by the interaction of the aircraft and the air flowing past it, which results in turbulent flows and consequently noise. It is particularly important to reduce noise created during approach of the aircraft on landing. During approach, a significant contribution to the amount of noise that the aircraft generates is made by the landing gear, which is typically deployed early for landing for safety reasons. The deployment of the landing gear increases drag and assists deceleration of the aircraft. During take-off, noise from the landing gear is a less significant factor because engine noise is generally greater and because the landing gear is generally stowed at the earliest opportunity to reduce drag and aid take-off. During normal flight, the landing gear of an aircraft is typically stowed in a landing gear bay, the bay being completely or partially closed by doors so that the landing gear is not subjected to the air flow.

WO2004/089743 describes an aircraft landing gear door assembly including a landing gear bay door for closing the aperture through which the landing gear is deployed. The door is additionally moveable so that at least a portion of the door acts as a fairing to reduce the noise caused by the landing gear, when the landing gear is in its fully deployed position. The landing gear bay door thus doubles up as a noise-reducing fairing. However, the ability of the door to reduce noise may need to be compromised in view of the need of the door to function additionally as a landing gear bay door. Also, complicated deployment mechanisms may need to be employed to allow the door additionally to be moved to a fairing position and/or configured as a fairing.

US 2006/0032981 also describes an aircraft landing gear door assembly including a set of a landing gear bay doors for closing a housing in which a landing gear is stored. A forward door may be rotated about a span-wise axis to assume a position in which the door shields at least part of the landing gear in its deployed position. In a similar manner to WO 2004/089743 however the door used to shield the landing gear is also required to function as a closing element of the housing in which the landing gear is stored.

The present invention seeks to mitigate the above-mentioned problems. Alternatively or additionally, the present invention seeks to provide an improved aircraft landing gear noise reduction assembly.

### SUMMARY OF THE INVENTION

The present invention provides, according to a first aspect, an aircraft noise reduction apparatus including an aircraft landing gear assembly and a noise reduction fairing as set out in claim 1. It will be noted that the noise reduction fairing is positioned fore of the landing gear bay door assembly and may therefore be entirely separate from, and independent of, the doors provided for closing the landing gear bay aperture. As such, the noise reduction fairing may have as its primary function the ability to reduce noise that would otherwise be generated by the interaction of the deployed landing gear assembly and the air flowing past it. The function of the noise reduction fairing need not therefore be compromised, and its design need not be complicated, by the need for the fairing to perform additionally the function of a landing gear bay door.

A second aspect of the invention provides an aircraft as set out in claim 15. The aircraft may be a fixed-wing aircraft and/or an aircraft that cannot land vertically.

The present invention yet further provides, according to a third aspect, a method of reducing noise caused by landing gear on an aircraft, as set out in claim 16. Preferred (but optional) features of the invention are set out in the dependent claims.

Other optional features are described in the “detailed description” below. For example, the noise reduction fairing may be arranged to be moveable independently of the landing gear. The noise reduction fairing may be arranged to be moveable independently of the landing gear bay door assembly. The noise reduction fairing may be mounted for rotational movement about an axis, which is substantially transverse to the length of the aircraft. The noise reduction apparatus may be arranged such that when the noise reduction fairing is in use in its deployed position it diverts air in a substantially downwards direction.

The present invention has particular application in relation to fixed-wing aircraft. The aircraft may be of a type that is unable to land vertically.

It will be appreciated that aspects of the present invention described in relation to the apparatus of the present invention are equally applicable to the method of the present invention and vice versa.

### DESCRIPTION OF THE DRAWINGS

By way of example an embodiment of the invention will now be described with reference to the accompanying schematic drawings, of which:

FIGS. 1a, 1b are views showing a part of an aircraft wing with closed landing gear bay doors and a stowed noise reduction fairing according to the embodiment of the invention, FIGS. 2a, 2b, 2c, 2d are views showing the aircraft wing of FIGS. 1a and 1b (with landing gear bay doors omitted for clarity) with the landing gear deployed and the noise reduction fairing deployed,

FIGS. 3a, 3b are views showing the aircraft wing of FIGS. 1a and 1b (with landing gear bay doors omitted for clarity) with the landing gear deployed, and the noise reduction fairing stowed, and

FIG. 4 is a partial cut-away view of the noise reduction fairing of the aircraft wing showing its actuating system.

### DETAILED DESCRIPTION

The embodiment of the invention illustrated by the accompanying drawings concerns an aircraft wing mounted landing gear 10 with a moveable noise reduction fairing 12. The aircraft (not separately illustrated) is a fixed-wing aircraft. The aircraft is equipped with fixed position jet engines and is arranged to land and take-off in a conventional (i.e. not vertical) manner (a conventional take-off and landing, or CTOL, aircraft). When the aircraft is making its approach on landing and the landing gear 10 is deployed, the noise reduction fairing 12 may be moved to its fully deployed position so that it acts to reduce noise that would otherwise be generated by the interaction of the deployed undercarriage (referred to herein as the landing gear assembly) and the air flowing past it. Such noise is thought to be created by air passing over the landing gear assembly 10, separating and creating a turbulent flow. The fairing 12 deflects the flow around and away from the poor aerodynamic aspects of the top part of the landing gear assembly in a controlled manner. It also shields part of the bay cavity when the bay is opened with gear deployed, thus reducing the bay cavity noise.

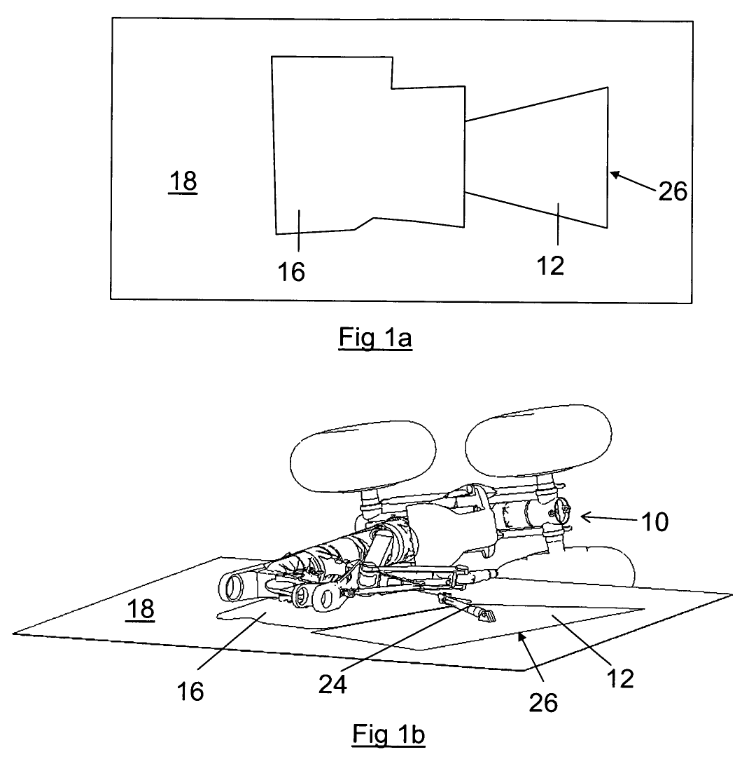

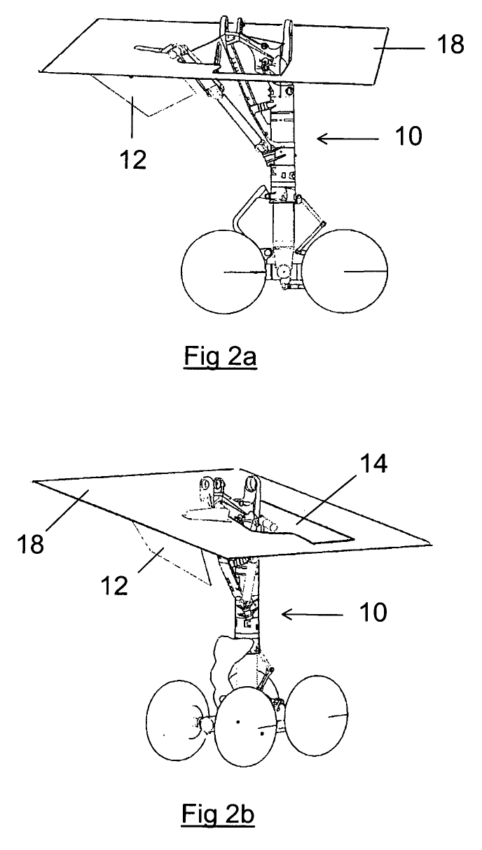

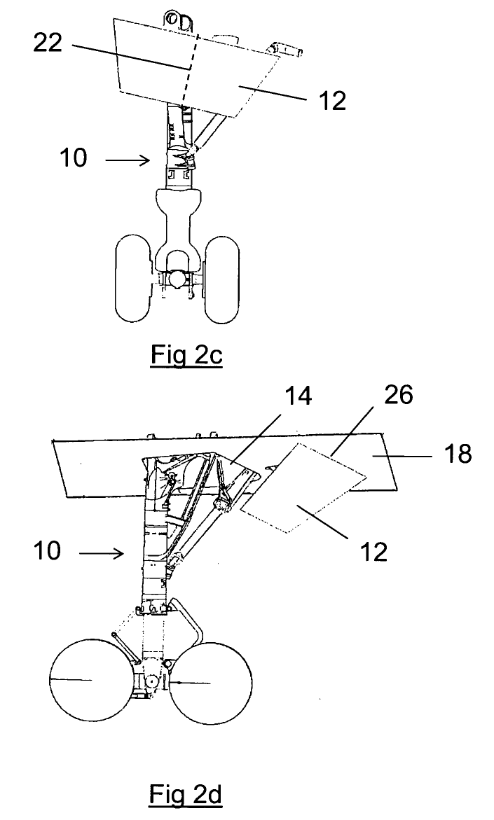

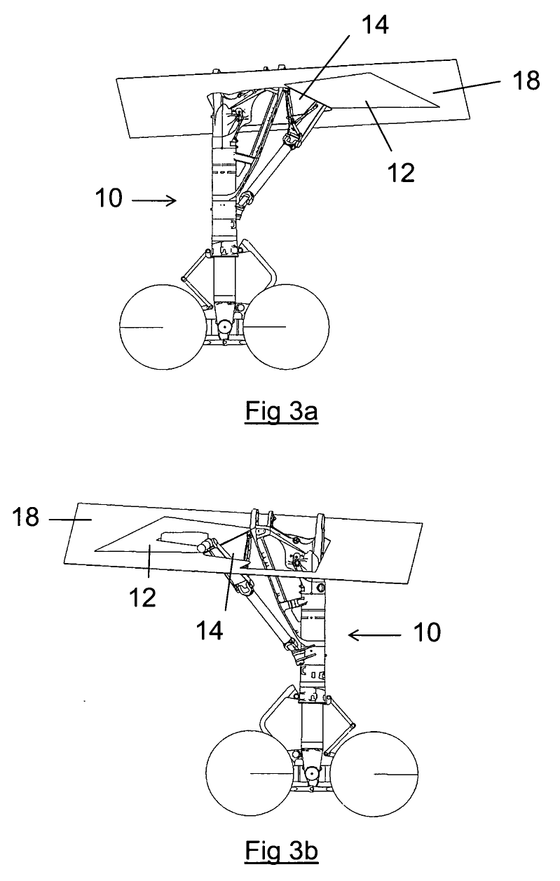

The landing gear is mounted for movement between a stowed position in which the landing gear is stowed in a bay in the wing (as shown in FIGS. 1a and 1b) and a fully deployed position (as shown in FIGS. 2a to 3b) in which the landing gear extends through an aperture 14 in the wing.

FIGS. 1a and 1b show the landing gear 10 in its stowed position and the landing gear bay doors 16 in their fully closed positions so that the landing gear bay aperture 14 is fully closed. When deploying the landing gear, the landing gear bay doors are opened to allow the landing gear to pass through the aperture of the landing gear bay. In its stowed position, the outer surface of the noise reduction fairing 12 is flush with the outer surface of the surrounding wing structure 18, thereby reducing drag that might otherwise be caused by the fairing 12 when the aircraft is in cruise.

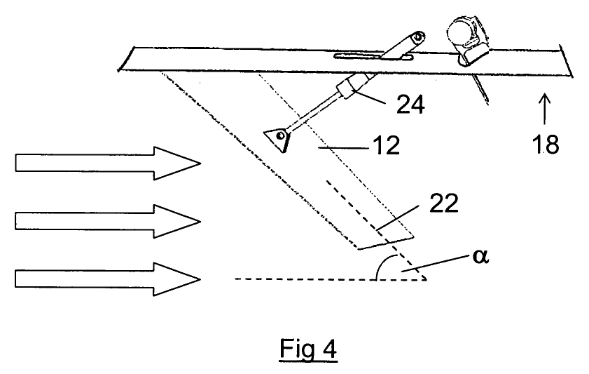

The wing includes a noise reduction fairing 12, which is positioned fore (upstream) of the landing gear bay door assembly. FIGS. 1a and 1b and FIG. 4a and 4b show the noise reduction fairing 12 in its stowed position. It will be seen from FIG. 1a that the average width (measured in the vertical direction as shown in FIG. 1a) of the noise reduction fairing 12 is less than the average width of the landing gear bay aperture. The fairing 12 is in the form of a trapezoidal panel having a fixed shape such that it tapers along its length from its fore end (to the left of FIG. 1a) to its aft end (to the right of FIG. 1a).

The noise reduction fairing 12 is moveable to a fully deployed position (shown in FIGS. 2a to 2d). When the fairing 12 is viewed in this position in a direction parallel to the length of the aircraft (as shown in FIG. 2c), the longitudinal centre line of the fairing 12 is aligned with the landing gear in its fully deployed position. It will be seen that the longitudinal centre line 22 of the fairing 12 is not exactly parallel with the landing gear leg, but that the longitudinal centre line of the fairing 12 is positioned substantially directly in front of, and within the bounds of, the area that envelopes the rest of the landing gear structure. The aft edge of the fairing 12 may for example be positioned between the sides (at their widest) of the landing gear bay aperture.

The landing gear bay doors are not shown in FIGS. 2a to 2d and 3a and 3b for the sake of clarity.

It will be noted that the noise reduction fairing 12 is positioned fore of the landing gear bay door assembly and may therefore be entirely separate from, and independent of, the doors provided for closing the landing gear bay aperture. As such, the noise reduction fairing 12 may have as its primary function the ability to reduce noise that would otherwise be generated by the interaction of the deployed landing gear assembly and the air flowing past it. The function of the noise reduction fairing 12 need not therefore be compromised, and its design need not be complicated, by the need for the fairing 12 to perform additionally the function of a landing gear bay door.

It will of course be appreciated that the landing gear bay doors are arranged such that all of the landing gear bay doors need to be moved to allow the landing gear to be deployed. The landing gear bay doors may be so arranged that none may be left in the fully closed position whilst the landing gear moves between its stowed position and its fully deployed position. Whilst a single landing gear door may be provided for closing the aperture, the present embodiment utilises a plurality of landing gear bay doors.

It will be seen from FIGS. 3a and 3b, that the noise reduction fairing 12 is so arranged that it may remain in the stowed position whilst the landing gear is in its fully deployed position. The noise reduction fairing 12 is thus so arranged that it does not need to be moved to allow the landing gear to be deployed. The noise reduction fairing 12 may thus be so arranged that it may be left in the fully closed position whilst the landing gear moves between its stowed position and its fully deployed position. Given that airframe noise is less of an issue when taking off (because engine noise tends to dominate and the undercarriage is typically retracted quickly to reduce drag); it may be desirable not to deploy the noise reduction fairing 12 during take-off. On landing, where the engines are at flight idle, airframe noise tends to dominate. The noise reduction fairing 12 is arranged to be moveable completely independently of the landing gear, which then allows the fairing 12 to be deployed only when desired. In this embodiment, the movement of the landing gear bay doors is mechanically linked to the movement of the landing gear. The noise reduction fairing 12 is therefore also moveable independently of the landing gear bay doors.

Thus, the noise-reduction fairing 12 may be used selectively. A method of operating an aircraft including using a fairing 12 of the embodiment may for example include causing the aircraft to take-off with the fairing 12 stowed but then subsequently causing the aircraft to land with the fairing 12 fully deployed. The steps performed in such a method will now be briefly described. With the landing gear in the fully deployed position the aircraft takes off. Subsequently, the landing gear is retracted and stowed and the landing gear bay doors are closed. During the period between take-off and initiation of the retracting of the landing gear, the noise reduction fairing 12 may be maintained in its fully closed position. The aircraft may then land (in a non-vertical direction) by opening the landing gear bay door and deploying the landing gear, and also deploying the noise reduction fairing 12 in front of the landing gear assembly, so as to reduce the noise on landing that would otherwise be generated by the interaction of the landing gear assembly when deployed and the air flowing past it.

FIG. 4 shows the noise reduction fairing 12 in its fully deployed position. It will be seen that movement between the stowed and deployed positions is effected by means of an actuator 24 (in this example, a hydraulic jack) rotatably mounted at one end to the fairing 12 and rotatably mounted at the opposite end to a fixed part of the wing structure (which has been omitted for the sake of clarity). The hydraulic actuator is located in a can type dry bay within the wing structure, similar to that of a slat track and can in the wing leading edge. The noise reduction fairing 12 is mounted for rotational movement about a hinge axis 26, which is substantially transverse to the length of the aircraft. The axis of rotation is in this embodiment substantially spanwise. In its deployed position the fairing 12 is in what can be described as a ramp-type fairing 12 configuration. The angle α of the ramp in its fully deployed position relative to the direction of airflow is about 40 degrees. In moving from its stowed position to its fully deployed position, the noise reduction fairing 12 undergoes rotational movement of about 40 degrees. The extension of the hydraulic ram is limited such that the fairing 12 is unable to rotate by more than this amount. The actuator 24 is protected by a cover omitted from FIG. 4 for the sake of clarity (but shown in FIGS. 2b and 3b).

As can be readily envisaged, the noise reduction fairing 12 when in its fully deployed position, acts as a ramp fairing 12 and thus diverts air in a substantially downwards direction. In the fully deployed position, the fairing 12 thus diverts air away from at least a portion of the landing gear, preferably noise generating parts of the landing gear, such as for example, the upper landing gear leg, sidestays, down-lock stays, actuators, and the like. The faring may act to divert air away from one or more of the landing gear bay doors.

As a result of the fairing 12 on each wing being moveable independently of the landing gear assemblies with which each is associated a control system is provided in the present embodiment to ensure that one fairing 12 is not deployed whilst the other is stowed. In the present embodiment, such a system is provided simply by means of providing the ability to deploy or stow the fairings together and not separately.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

In the illustrated embodiment, none of the noise reduction fairing when in the stowed position covers over the landing gear bay aperture. In an alternative embodiment, a small minority of the noise reduction fairing when in the stowed position covers over the landing gear bay aperture. In such a case, it may be necessary for the noise reduction fairing to be moved clear of the landing gear bay aperture to allow the landing gear to be deployed through the aperture.

In the illustrated embodiment, the noise reduction fairing when in the stowed position has an edge that abuts an edge of a landing gear bay door. In an alternative embodiment, the noise reduction fairing is spaced apart from the landing gear bay aperture.

The aperture need not be fully closed when the landing gear bay doors are in the fully closed configuration.

In the illustrated embodiment, the noise reduction fairing is mounted for rotational movement about a fixed axis, which is substantially transverse to the length of the aircraft. Using fixed-axis rotation enables a simple and reliable design to be provided. In an alternative embodiment, the noise reduction fairing is mounted such that its movement is a complex combination of translational and rotational movements.

The noise reduction fairing may in certain embodiments of the invention have a shape that is changeable. For example, the noise reduction fairing may include a part that moves to improve its function of a fairing and/or is moveable to improve stowability of the fairing.

It will of course be appreciated that whilst the illustrated embodiment concerns reducing noise caused by a wing-mounted landing gear, the invention has application to landing gear assemblies in other positions on the aircraft. The noise reduction fairing may for example be associated with a nose landing gear, or a main landing gear assembly associated with the fuselage.

The noise-reduction fairing may have a shape and configuration which, when deployed, provides lift. For example, the fairing may have an aero-foiled shape in streamwise section rather than a constant thickness. Also the hinge set-up could be different such that the fore edge of the fairing is moved downwards when deploying the fairing.

Whilst it is currently intended that the ramp fairing is totally independent from the undercarriage and would only be deployed for the approach sector of flight (and that the fairing would not be used for take off), the fairing could also be deployed at take off, if airframe noise were ever to become important (for example if engine noise were to be reduced significantly).

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. Aircraft noise reduction apparatus including an aircraft landing gear assembly and a noise reduction fairing, wherein
the landing gear assembly comprises
a landing gear bay having an aperture,
a landing gear moveable between a stowed position in which the landing gear is stowed in the landing gear bay and a fully deployed position, and
a landing gear bay door assembly comprising at least one door, the door assembly being moveable between (i) an open configuration in which the aperture of the landing gear bay is sufficiently exposed to allow deployment of the landing gear and (ii) a fully closed configuration in which the landing gear bay aperture is substantially closed,
the noise reduction fairing is positioned fore of the landing gear bay door assembly, and
the noise reduction fairing is moveable between a stowed position and a fully deployed position such that in the fully deployed position, the noise reduction fairing acts to reduce noise that would otherwise be generated by the interaction of the landing gear assembly when the landing gear is deployed and the air flowing past the landing gear assembly.

2. Aircraft noise reduction apparatus according to claim 1, wherein the noise reduction fairing is arranged such that it may remain in the stowed position whilst the landing gear is in its fully deployed position.

3. Aircraft noise reduction apparatus according to claim 1, wherein the noise reduction fairing is so arranged that it does not need to be moved to allow the landing gear to be deployed.

4. Aircraft noise reduction apparatus according to claim 1, wherein at least the majority of the noise reduction fairing when in the stowed position does not cover over the landing gear bay aperture.

5. Aircraft noise reduction apparatus according to claim 1, wherein the apparatus includes aircraft structure, which defines a recess which accommodates the noise-reduction fairing when in the stowed position such that the outward-facing surface of the noise-reduction fairing lies flush with the surface of the surrounding aircraft structure.

6. Aircraft noise reduction apparatus according to claim 1, wherein the noise reduction fairing is arranged for rotational movement about an axis of between 10 and 50 degrees to effect movement of the noise reduction fairing between its stowed position and its fully deployed position, the axis being substantially transverse to the length of the aircraft.

7. Aircraft noise reduction apparatus according to claim 1, wherein the noise reduction fairing is in the form of a fixed shape noise reduction fairing.

8. Aircraft noise reduction apparatus according to claim 1, wherein the average width of the noise reduction fairing is less than the average width of the landing gear bay aperture.

9. Aircraft noise reduction apparatus according to claim 1, wherein the width of the noise reduction fairing tapers along its length from its fore end to its aft end.

10. Aircraft noise reduction apparatus according to claim 1, wherein the noise reduction fairing has a longitudinal centre line which, when the noise reduction fairing is in its fully deployed position, is aligned with the landing gear in its fully deployed position when viewed in a direction parallel to the length of the aircraft.

11. Aircraft noise reduction apparatus according to claim 1, wherein the landing gear is a wing mounted landing gear.

12. An aircraft including an aircraft noise reduction apparatus according to claim 1.

13. An aircraft according to claim 12, wherein the aircraft is a fixed wing aircraft

14. A method of reducing noise caused by landing gear on an aircraft, the method comprising the following steps:
providing an aircraft according to claim 12, and
landing the aircraft, wherein
during landing of the aircraft and before touchdown, the following steps are performed:
opening the landing gear bay door assembly and deploying the landing gear, and
deploying the noise reduction fairing in front of the landing gear assembly, thus reducing the noise that would otherwise be generated by the interaction of the landing gear assembly when deployed and the air flowing past it.

15. A method of reducing noise according to claim 14, wherein the method further comprises the following steps:
causing the aircraft to take-off with the landing gear in the fully deployed position,
subsequently retracting and stowing the landing gear and closing the landing gear bay door assembly, and
during the period between take-off and initiation of the retracting of the landing gear, maintaining the noise reduction fairing in its fully closed position.
